(19) United States
(12) Patent Application Publication
(10) Pub. No.: US 2026/0022292 A1
(43) Pub. Date: Jan. 22, 2026

(54) STRUCTURE WITH LUMINESCENT NANOSTRUCTURES

(71) Applicant: Shoei Chemical Inc., Tokyo (JP)

(72) Inventors: ULADZIMIR SAYEVICH, San Jose, CA (US); AUSTIN SMITH, Redwood, CA (US); CHUNMING WANG, Livermore, CA (US); ILAN Jen-La Plante, San Jose, CA (US); ALEXANDER SAEBOE, Milpitas, CA (US); MARIA JOSE BAUTISA, San Jose, CA (US); ANTHONY SAN MATEO, Dublin, CA (US); KELBY HULL, Oakland, CA (US); MARK BOKCHTEIN, Milpitas, CA (US)

(21) Appl. No.: 19/153,206

(22) PCT Filed: Feb. 2, 2024
(86) PCT No.: PCT/US2024/014346

§ 371 Date: Aug. 1, 2025

Related U.S. Application Data
(60) Provisional application No. 63/443,281, filed on Feb. 3, 2023.
(60) Provisional application No. 63/454,199, filed on Mar. 23, 2023.
(60) Provisional application No. 63/516,381, filed on Jul. 28, 2023.
(60) Provisional application No. 63/607,879, filed on Dec. 8, 2023.

(51) Int. Cl. C09K 11/02; C09D 7/48; C09D 7/65; C09K 11/62; C09K 11/88

(52) U.S. Cl. CPC C09K 11/025; C09D 7/48; C09D 7/65; C09K 11/621; C09K 11/883

(57) ABSTRACT

A composition comprises a carrier matrix; a plurality of photoluminescent nanostructures distributed within the carrier matrix; a hindered amine stabilizer; and at least one of (i) an alkylalkoxysilane and a coordination polymer, or (ii) a silanized coordination polymer.

### CROSS REFERENCE TO RELATED APPLICATIONS

The present application is based upon and claims priority under 35 U.S.C. 119(e) to U.S. Provisional Patent Application No. 63/443,281, filed Feb. 3, 2023, entitled STRUCTURE WITH LUMINESCENT NANOSTRUCTURES, U.S. Provisional Patent Application Ser. No. 63/454,199, filed Mar. 23, 2023, entitled STRUCTURE WITH LUMINESCENT NANOSTRUCTURES, U.S. Provisional Patent Application No. 63/516,381, filed Jul. 28, 2023, entitled COMPOSITION WITH LUMINESCENT NANOSTRUCTURES, and U.S. Provisional Patent Application No. 63/607,879, filed Dec. 8, 2023, entitled SUPPLEMENTARY AMINE ADDITIVES FOR QUANTUM-DOT PHOTOLUMINESCENCE STABILITY, the entireties of which are hereby incorporated herein by reference for all purposes.

### BACKGROUND

Poor operational stability of quantum dots under photoexcitation in humid environments may be remedied by overlaying so-called ‘barrier layers’ on quantum dot (QD) optical film products, for example QD resin layers, to reduce exposure of the QDs to moisture. That approach increases QD layer thickness and cost and limits the availability of the resulting QD optical film.

Thus, to reduce manufacturing cost and complexity, elimination of the barrier layers may be desirable. However, doing so may expose the QDs to conditions (e.g., moisture and/or air) that degrade performance.

### SUMMARY

One disclosed example provides a composition comprising a carrier matrix, a plurality of photoluminescent nanostructures distributed within the carrier matrix, a hindered amine stabilizer, and at least one of (i) an alkylalkoxysilane and a coordination polymer, or (ii) a silanized coordination polymer.

In some such examples, the plurality of photoluminescent nanostructures comprise one or more of indium phosphide (InP)-based quantum dots, silver indium gallium sulfide (AIGS)-based quantum dots, or cadmium selenide (CdSe)-based quantum dots.

Alternatively or additionally, in some such examples, the at least one of (i) the alkylalkoxysilane and the coordination polymer or (ii) a silanized coordination polymer and the hindered amine stabilizer are stabilizing additives, and wherein the stabilizing additives and the plurality of photoluminescent nanostructures are distributed together as heterogeneous domains within the carrier matrix, such that the photoluminescent nanostructures are in direct contact with the stabilizing additives.

Alternatively or additionally, in some such examples, the composition further comprises a secondary antioxidant compound dispersed in the carrier matrix and configured to decompose at least one hydroperoxide.

Alternatively or additionally, in some such examples, the secondary antioxidant compound comprises phosphorus and/or sulfur.

Alternatively or additionally, in some such examples, the secondary antioxidant compound has the structure:

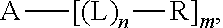

wherein A is a moiety with secondary antioxidant functionality;
each L is a linker group selected from phenyl, —O— and —S—;
n is 0 or 1;
each R is independently a substituted or unsubstituted C₆₋₄₀ hydrocarbon group; and
m is a number from 1 through 6.

Alternatively or additionally, in some such examples, the hindered amine stabilizer, the at least one of (i) the alkylalkoxysilane and the coordination polymer or (ii) a silanized coordination polymer, and the secondary antioxidant are stabilizing additives, and wherein the plurality of photoluminescent nanostructures and the stabilizing additives are distributed together as heterogeneous domains within the carrier matrix, such that the photoluminescent nanostructures are in direct contact with the stabilizing additives.

Alternatively or additionally, in some such examples, the composition further comprises a supplementary base dispersed in the carrier matrix.

Alternatively or additionally, in some such examples, the supplementary base comprises melamine or a melamine derivative.

Alternatively or additionally, in some such examples, the supplementary base comprises a melamine-based product of a Mannich condensation.

Alternatively or additionally, in some such examples, the supplementary base comprises a salt of melamine or of a melamine derivative.

Alternatively or additionally, in some such examples, the supplementary base comprises a triazine compound.

Alternatively or additionally, in some such examples, the supplementary base comprises a cyanamide condensate.

Alternatively or additionally, in some such examples, the supplementary base comprises an aromatic imine base.

Alternatively or additionally, in some such examples, the supplementary base comprises a metal carbonate.

Alternatively or additionally, in some such examples, the metal carbonate is lithium carbonate.

Alternatively or additionally, in some such examples, the at least one of (i) the alkylalkoxysilane and the coordination polymer or (ii) a silanized coordination polymer, the hindered amine stabilizer, and the supplementary base are stabilizing additives, and wherein the stabilizing additives and the plurality of photoluminescent nanostructures are distributed together as heterogeneous domains within the carrier matrix, such that the photoluminescent nanostructures are in direct contact with the stabilizing additives.

Alternatively or additionally, in some such examples, the composition further comprises a support particle.

Alternatively or additionally, in some such examples, the support particle comprises a material for scattering light of at least one of: a wavelength absorbed by the luminescent nanostructures or a wavelength emitted by the luminescent nanostructures.

Alternatively or additionally, in some such examples, the support particle has a band gap of greater than 3 eV.

Alternatively or additionally, in some such examples, the support particle comprises at least one of: an inorganic material, a metal oxide, a metal sulfide, or one or more of SiO₂, TiO₂, ZnO or ZnS.

Alternatively or additionally, in some such examples, the composition further comprises a coating at least partially surrounding the support particle.

Alternatively or additionally, in some such examples, the coating is formed from at least one of:
a) at least one material selected from the group consisting of: an alkoxy silane with a linear or branched alkyl substituent; an alkoxy silane with at least one phenyl, mercapto, or amino substituent; an alkoxy silane with at least one cross-linkable reactive functional group; an alkoxy silane with at least one halide functional group; a tetra-alkoxy silane; an alkali, alkaline earth or transition metal silicate; or a group (IV) or transition metal alkoxide; and/or
b) at least one material selected from the group consisting of: a metal thiolate; a metal carboxylate; a fluoropolymer; a butylene/isoprene copolymer; a styrene-ethylene/butylene-styrene copolymer; a styrene-ethylene/propylene-styrene copolymer; polyvinylidene dichloride or a high boiling point wax.

Alternatively or additionally, in some such examples, the coating comprises a silanized coordination polymer.

Alternatively or additionally, in some such examples, the coating comprises a silanized coordination polymer which is the reaction product of an alkyl alkoxy silane and a metal thiolate.

Alternatively or additionally, in some such examples, the coordination polymer comprises a metal thiolate.

Another example provides a screen. The screen comprises a hardened composition including a carrier matrix, a plurality of photoluminescent nanostructures distributed within the carrier matrix, a hindered amine stabilizer, and at least one of (i) an alkylalkoxysilane and a coordination polymer, or (ii) a silanized coordination polymer.

In some such examples, the carrier matrix comprises a thermoplastic material or a pre-cursor to a thermoplastic material, and wherein the hardened composition further comprises a secondary antioxidant compound dispersed in the carrier matrix and configured to decompose at least one hydroperoxide.

Another example provides a display device. The display device comprises a screen including a hardened composition. The hardened composition comprises a carrier matrix, a plurality of photoluminescent nanostructures distributed within the carrier matrix, a hindered amine stabilizer, and at least one of (i) an alkylalkoxysilane and a coordination polymer, or (ii) a silanized coordination polymer.

In some such examples, the screen is a substantially planar solid structure, and wherein the hardened composition further comprises a supplementary base dispersed in the carrier matrix.

Alternatively or additionally, in some such examples, the supplementary base comprises a melamine-based product of a Mannich condensation.

### BRIEF DESCRIPTION OF THE DRAWINGS

FIG. 1 shows schematically a perspective view of a film of examples.

FIGS. 2 and 3 show schematically a section view of a structure of examples.

FIGS. 4A and 4B show schematically a side cross-section of apparatus of different examples.

FIGS. 5A and 5B show performance data for luminescent nanostructures within structures of examples.

FIGS. 6A through 6D show performance data for luminescent nanostructures within structures of examples.

FIG. 7A shows the molecular structure of 2,2,6,6-tetramethylpiperidin-4-yl, usable herein as a hindered amine light stabiliser.

FIG. 7B shows the molecular structures of melamine, usable herein as a supplementary base.

FIG. 7C shows the molecular structure of an example substituted melamine compound, usable herein as a supplementary base.

FIG. 8 shows performance data for example photoluminescent nanostructures used in the examples and comparative examples herein.

FIGS. 9A, 9B, 10A, and 10B show performance data for example photoluminescent nanostructures used in the examples

FIG. 11 shows selected reliability data for green-and red-emitting QDs under different testing conditions.

FIGS. 12A and 12B show aspects of an example display device.

FIG. 13 shows aspects of an example electronic device.

### DETAILED DESCRIPTION

In examples described herein, structures are provided in which luminescent nanostructures such as quantum dots are located within a coating which at least partially surrounds a support particle. The coating at least partly protects the nanostructures from, for example, moisture and/or air, which may otherwise adversely affect the structural and/or optical properties of the nanostructure. The support particle may also at least partly protect the nanostructures from environmental factors like moisture and/or air. In this way the coating and/or the support particle may be considered to function as a barrier material or layer. Thus a separate barrier film (e.g., in a so-called quantum-dot enhancement film (QDEF film)) may not be needed to protect nanostructures from moisture and/or air.

Further, the coating and support particle may also function to space the nanostructures (each as part of a structure and/or of adjacent structures) from each other, reducing aggregation and quenching of their optical properties.

In other examples described herein, structures are provided in which one or a plurality of luminescent nanostructures are located within a material, wherein the material is formed from at least one material selected from the group consisting of: an alkoxy silane with a linear or branched alkyl substituent; an alkoxy silane with at least one phenyl, mercapto, or amino substituent; an alkoxy silane with at least one cross-linkable reactive functional group; an alkoxy silane with at least one halide functional group; a tetra-alkoxy silane; an alkali, alkaline earth or transition metal silicate; or a group (IV) or transition metal alkoxide; and at least one material selected from the group consisting of: a metal thiolate; a metal carboxylate; a fluoropolymer; a butylene/isoprene copolymer; a styrene-ethylene/butylene-styrene copolymer; a styrene-ethylene/propylene-styrene copolymer; polyvinylidene dichloride or a high boiling point wax. The material provides protection from, for example, moisture and/or air, which may otherwise adversely affect the structural and/or optical properties of the nanostructure. The material may also function to space the nanostructures (each as part of a structure and/or of adjacent structures) from each other, reducing aggregation and quenching of their optical properties.

Examples will now be described with reference to the drawings. In the description which follows, a feature of a later drawing figure may correspond with a feature of an earlier drawing figure.

In some examples, the coating at least partially surrounds a support particle (and in some examples, completely surrounds the support particle). A structure 203 of such examples herein is now described with reference to FIG. 2. A support particle 211 is surrounded by a coating 213, which has luminescent nanostructures 215 within it.

The support particle is for example a particle or body which supports the coating and the luminescent nanostructures within the coating. Thus the support particle itself may not be luminescent, nor comprise a luminescent nanostructure. The support particle may be approximately spherical (e.g., spherical within acceptable manufacturing tolerances) in some examples. The coating is, e.g., a material which coats or covers as a layer the support particle. The structure can therefore, in examples, be considered to have a core-shell structure, where the core corresponds to the support particle and the shell corresponds to the coating. The coating may be directly in contact with the support particle or there may be one or more other layer between the support particle and the coating. In some examples, the coating is approximately uniform in thickness so that the resulting structure is approximately spherical. In some examples, the coating is not uniform in thickness; however, in such examples the relatively small thickness of the coating and the approximate spherical nature of the support particle means that the resulting structure may also be approximately spherical. This can assist dispersion and/or mixing of the structures in a carrier material (explained later), for use e.g., in a film or other element of a display device. In other examples, the support particle and/or particle may be non-spherical, such as cubic.

With an appropriate concentration and dispersion of the nanostructures within the coating, a spacing between nanostructures within the coating can be set in accordance with desired light absorption and/or emitting properties.

The support particle 211 also determines a spacing between nanostructures, e.g., within opposite portions of the coating. A plurality of structures may also tend to reduce concentration of nanostructures through inefficient packing of the larger structures compared with freely dispersed nanostructures which may tend to aggregate more densely. Additionally, and without being bound by theory, it is thought that the presence of the support particle further limits exposure to moisture and/or air as the coating is exposed to moisture/air on the outer surface and not the inner surface.

In some examples, the material, shape and/or size of the support particle can be selected to give desired optical functionality. For example, the support particle comprises or is substantially formed (e.g., entirely comprises within acceptable purity tolerances) from a material for scattering light, e.g., light of a wavelength absorbed by the nanostructures and/or light of a wavelength emitted by the luminescent nanostructures.

This light scattering property, e.g., increases the effective path length in proximity to the luminescent nanostructures, thereby increasing coincidence of excitation photons with the nanostructures and increasing down-conversion efficiency. In some such examples, the material forming the support particle has a band gap of greater than about 3 eV (electron Volts). With a bandgap in this range the carrier particles do not appreciably absorb relatively short (e.g., blue)-wavelength excitation, but function primarily as scattering particles. The support particle may have a maximum dimension, e.g., a diameter, 217 between about 100 nm (nanometers) and about 10 μm (micrometers) (e.g., less than about 5 μm, 3 μm, 2 μm, 1.8 μm, or 1.5 μm). A soft upper bound on the dimension provides efficient scattering of relatively short-wavelength light as well as optical uniformity in the thin films. In examples, the support particle is solid and/or in the solid phase. In some examples the support particle comprises an inorganic material. And in some examples, the support particle comprises a metal oxide or sulfide, e.g., one or more of SiO₂ (silicon dioxide), TiO₂ (titanium dioxide), ZnO (zinc oxide) or ZnS (zinc sulfide).

The coating 213 is formed from a material which is optically transparent, at least for one or more wavelengths of the input (excitation) and output (emission) light for the luminescent nanostructures.

In some examples, the coating may comprise or be derived from at least one material selected from the group consisting of: a metal thiolate; a metal carboxylate; a fluoropolymer; a butylene/isoprene copolymer; a styrene-ethylene/butylene-styrene copolymer; a styrene-ethylene/propylene-styrene copolymer; polyvinylidene dichloride or a high boiling point wax (e.g., a wax with a boiling point in excess of about 100° C., 150° C., 200° C. or 250° C.). The extrusion and/or film making process typically runs at relatively high temperature, such that a wax of relatively high boiling point is useful. Such coating materials at least party repel water (and can thus be considered hydrophobic). In some examples, the coating comprises a coordination polymer derived from a metal thiolate and/or a metal carboxylate.

In some examples, the coating may be formed from at least one of:
a) at least one material selected from the group consisting of: an alkoxy silane with a linear or branched alkyl substituent; an alkoxy silane with at least one phenyl, mercapto, or amino substituent; an alkoxy silane with at least one reactive functional group; an alkoxy silane with at least one halide functional group; a tetrafunctional alkoxy silane; an alkali, alkaline earth or transition metal silicate; or a group (IV) or transition metal alkoxide; and/or
b) at least one material selected from the group consisting of: a metal thiolate; a metal carboxylate; a fluoropolymer; a butylene/isoprene copolymer; a styrene-ethylene/butylene-styrene copolymer; a styrene-ethylene/propylene-styrene copolymer; polyvinylidene dichloride or a high boiling point wax.

Such coating materials at least party repel water (and can thus be considered hydrophobic).

In some examples, the coating may be formed from at least one material selected from the list of paragraph a) and not b), or b) and not a). In some examples, the coating may be formed from at least one material selected from the list of paragraph a) and at least one material selected from the list of paragraph b), and possibly from another list.

An example of an alkoxy silane with a linear or branched alkyl substituent is hexyltrimethoxysilane. Examples of an alkoxy silane with at least one phenyl, mercapto, or amino substituent include phenyltrimethoxysilane, (3-mercaptopropyl)trimethoxysilane and 3-aminopropyltrimethoxysilane, In some examples, the cross-linkable reactive functional group is a group which could react in a resin or monomer matrix to crosslink through covalent bonding into the organic surroundings. In some examples, the cross-linkable reactive functional group is an unsaturated terminal group, such as terminal alkenes, acrylates, methacrylates, etc., Examples of an alkoxy silanes with at least one cross-linkable reactive functional group include vinyltrimethoxysilane, 3-(trimethoxysilyl)propyl acrylate and 3-(trimethoxysilyl)propyl methacrylate and the like. An example of an alkoxy silane with at least one halide functional group is chlorotrimethoxysilane. Examples of tetra-alkoxysilanes include tetramethylorthosilicate or tetraethylorthosilicate.

In some examples the metal thiolate or metal carboxylate is capable of forming a coordination polymer, such as zinc dodecanethiolate. In some examples, the fluoropolymer is a fluorocarbon polymer which is fully or partially fluorinated along the carbon backbone, such as PTFE.

In some examples, the weight ratio of the components listed in the preceding paragraphs a) and b) may be, a:b in the range of about 1:50 to about 2:1. In some examples, the weight ratio may be in the range of about 1:3 to about 1:7, and suitably in the range of 1:4 to about 1:6. In some examples, the weight ratio may be about 1:5.

In some examples, the coating comprises a silanized coordination polymer, suitably a silanized coordination polymer which is the reaction product of an alkyl alkoxy silane and a metal thiolate, and in some examples, a silanized coordination polymer which is the reaction product of a linear alkyl alkoxy silane and a metal thiolate. In some examples, the coating may be formed form an alkyl alkoxysilane and a metal thiolate, with a weight ratio of alkyl alkoxysilane to metal thiolate of approximately 1:5. In some cases, the coating may be formed from hexyltrimethoxysilane and zinc dodecanethiolate.

In some examples, the silanized coordination polymer may be the reaction product of an alkyl alkoxy silane and a metal thiolate in the presence of a surfactant. In some such examples, the surfactant may be an anionic surfactant, which may contain a sulfate, sulfonate, phosphate and/or carboxylate group. In some particular examples, the anionic surfactant may be an alkyl sulfate such as ammonium dodecyl sulfate and sodium dodecyl sulfate, or an alkyl-ether sulfate such as sodium laureth sulfate and sodium myreth sulfate. In some particular examples the anionic surfactant may be sodium dodecyl sulfate. The presence of a surfactant during the reaction of an alkyl alkoxy silane and a metal thiolate may in some examples improve the emission brightness, the emission power retention and/or the stability of the emission wavelength over time.

In some examples, the thickness 221 of the coating applied to a support particle is between about 10 nm and about 500 nm, suitably between about 10 nm and about 300 nm or about 200 nm. (The thickness, e.g., refers to the distance measured from the point of contact of the coating with the support particle surface to the outer surface of the coating, measured orthogonally to the surface of the support particle.

In some examples, the weight ratio of the luminescent nanostructures 215 to the coating 213 material is in the range of about 1:1 to about 1:30. The loading of luminescent nanostructures is, e.g., selected to achieve the required light emission intensity, which is also affected by the quantum efficiency of the nanostructures. In some examples, the weight ratio of the support particle to the coating (including the nanostructures within the coating) is in the range of about 1:1 to 1:2, and in some examples, may be about 2:3.

In some examples the maximum dimension, e.g., a diameter 219, of the structure 203 is up to about 10 μm, suitably up to about 5 μm, 3 μm, or 2 μm. Structures with a maximum dimension of less than about 2 μm can be more readily incorporated into a film whilst maintaining optical uniformity of that film.

In some examples, the luminescent nanostructures 215 are photoluminescent. That is, incident light excites the nanostructures, which then luminesce at a longer wavelength. In some examples the luminescent nanostructures are quantum dots, and in some examples, the quantum dots comprise at least one of: zinc telluride selenide (ZnTeSe), zinc telluride (ZnTe), zinc selenide (ZnSe), zinc sulfide (ZnS), indium phosphide (InP), indium gallium phosphide (InGaP), indium arsenide (InAs), indium zinc phosphide (InZnP), indium arsenide (InAs), indium arsenide phosphide (InAsP), indium gallium arsenide phosphide (InGaAsP), silver indium gallium sulphide (AgInGaS or AIGS), copper indium sulfide (CuInS or CIS), copper indium gallium selenide (CuInGaSe or CIGS), cadmium selenide (CdSe), cadmium sulfide (CdS), cadmium telluride (CdTe), cadmium selenide telluride (CdSeTe), cadmium zinc selenide (CdZnSe), molybdenum sulphide (MoS), or an alloy thereof. The quantum dots may have a core-shell structure as elaborated later. The quantum dots may be configured to absorb incident blue light and emit red or green light.

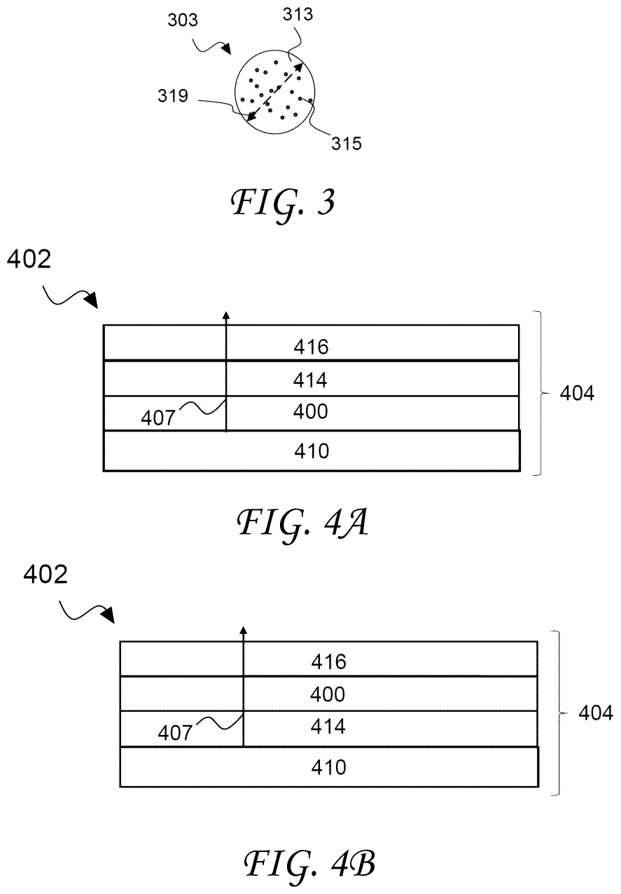

In some other examples, the structure comprises a material with one or a plurality of luminescent nanostructures within it. A structure 303 of such examples herein is now described with reference to FIG. 3 and has a material 313 with a plurality of luminescent nanostructures 315 embedded within. In other examples, there may be only one luminescent nanostructure 315 in the material, per structure. In some examples the material may be referred to as a barrier material.

In such examples without a support particle, the structure may be, for example, approximately spherical. In some examples, it may be a film of material with a plurality of nanostructures within.

In such examples (without a support particle), the material is formed from:
a) at least one material selected from the group consisting of: an alkoxy silane with a linear or branched alkyl substituent; an alkoxy silane with at least one phenyl, mercapto, or amino substituent; an alkoxy silane with at least one cross-linkable reactive functional group; an alkoxy silane with at least one halide functional group; a tetra-alkoxy silane; an alkali, alkaline earth or transition metal silicate; or a group (IV) or transition metal alkoxide; and
b) at least one material selected from the group consisting of: a metal thiolate; a metal carboxylate; a fluoropolymer; a butylene/isoprene copolymer; a styrene-ethylene/butylene-styrene copolymer; a styrene-ethylene/propylene-styrene copolymer; polyvinylidene dichloride or a high boiling point wax.

In some examples the metal thiolate or metal carboxylate is capable of forming a coordination polymer, such as zinc dodecanethiolate. Accordingly, the ‘coordination polymer’ herein may comprise, optionally, a metal thiolate. In some examples, the fluoropolymer is a fluorocarbon polymer which is fully or partially fluorinated along the carbon backbone, such as PTFE. More generally, at least one of (i) an alkylalkoxysilane and a coordination polymer, or (ii) a silanized coordination polymer, may be referred to as ‘stabilizing macromolecular additives’, and are one type of various types of stabilizing additives that may be used in an example according to the present disclosure.

In some examples, the weight ratio of the materials listed in the preceding paragraphs a) and b) may be, a:b in the range of about 1:50 to about 2:1. In some examples, the weight ratio may be in the range of about 1:3 to about 1:7, and suitably in the range of 1:4 to about 1:6. In some examples, the weight ratio may be about 1:5.

In some examples, the material comprises a silanized coordination polymer, suitably a silanized coordination polymer which is the reaction product of an alkyl alkoxy silane and a metal thiolate, and in some examples, a silanized coordination polymer which is the reaction product of a linear alkyl alkoxy silane and a metal thiolate. In some examples, the coating may be formed form an alkyl alkoxysilane and a metal thiolate, with a weight ratio of alkyl alkoxysilane to metal thiolate of approximately 1:5. In some cases, the coating may be formed from hexyltrimethoxysilane and zinc dodecanethiolate.

In some examples, the silanized coordination polymer may be the reaction product of an alkyl alkoxy silane and a metal thiolate in the presence of a surfactant. In some such examples, the surfactant may be an anionic surfactant, which may contain a sulfate, sulfonate, phosphate and/or carboxylate group. In some particular examples, the anionic surfactant may be an alkyl sulfate such as ammonium dodecyl sulfate and sodium dodecyl sulfate, or an alkyl-ether sulfate such as sodium laureth sulfate and sodium myreth sulfate. In some particular examples the anionic surfactant may be sodium dodecyl sulfate. The presence of a surfactant during the reaction of an alkyl alkoxy silane and a metal thiolate may in some examples improve the emission brightness, the emission power retention and/or the stability of the emission wavelength over time.

Description above relating to the luminescent nanostructures, the structure size (e.g., maximum dimension 319) and the weight ratio of nanostructure to material all apply equally to these examples.

Methods of fabricating the structures of examples described above are now given, followed then by a description of other compositions, films and apparatus comprising the structures.

Structures containing support particles may be formed by a) mixing luminescent nanostructures with at least one of: a coating material or one or more pre-cursor for the coating material, to form a first mixture; b) contacting the first mixture with a support particle; and c) forming a coating from the first mixture, the coating at least partially surrounding the support particle, the luminescent nanostructures within the coating.

In some examples, the method comprises mixing luminescent nanostructures with a first pre-cursor of the coating to form a first mixture, mixing support particles and a second pre-cursor of the coating to form a second mixture, and combining the first and second mixtures. In some such examples, the first mixture may be provided in a solvent, such as a non-polar organic solvent (e.g., toluene, chloroform), which is removed after the two mixtures are combined.

In some methods, where a support particle is present in the structure to be made, a catalyst or binder may be added to the mixture which encourages the coating to attach to the support particle. In some examples this might be tetrabutylammonium chloride, or similar. Other suitable materials include 1) reactive silanes, 2) multifunctional molecules with carboxy or phosphonic acid, mercapto, silyl, amino, allyl, or acrylate moieties, 3) acid/base catalysts including quaternary ammonium salts and hydroxides. The nature of the attachment could be through van der Waals type interactions for QD ligands, functionalized scatter media, and binder molecules containing alkyl chain functional groups. Alternatively, covalent bonds could be formed between these same groups (ligands, surface functionalization, binder) preferably through thermally activated ‘click’ type reactions (for example thiol-ene or amine/acid anhydride).

Structures without support particles may be formed by mixing luminescent nanostructures and the material or one or more pre-cursor of the material. In some examples the luminescent nanostructures may be in a solvent which is removed subsequently. In some examples, the method may comprise mixing luminescent nanostructures with a first pre-cursor for the material to form a first mixture, and then mixing in a second pre-cursor for the material. In some such examples, the first mixture may be provided in a solvent, such as a non-polar organic solvent, which is removed after the second pre-cursor for the material is added.

A composition according to examples herein includes a plurality of structures within a carrier material, wherein each structure is a structure according to the foregoing disclosure. In some examples, the carrier material is a thermoplastic material or a pre-cursor to the thermoplastic material. In some examples, the thermoplastic material comprises polystyrene. In some examples, the carrier material is liquid. In other examples, the composition is a film with a solid carrier material, which in some examples has a thickness in the range of about 0.03 mm (millimeters) to about 3.0 mm, in the range of about 0.3 to about 3.0 mm, or in the range of about 0.5 mm to 1.5 mm, or about 1.0 mm.

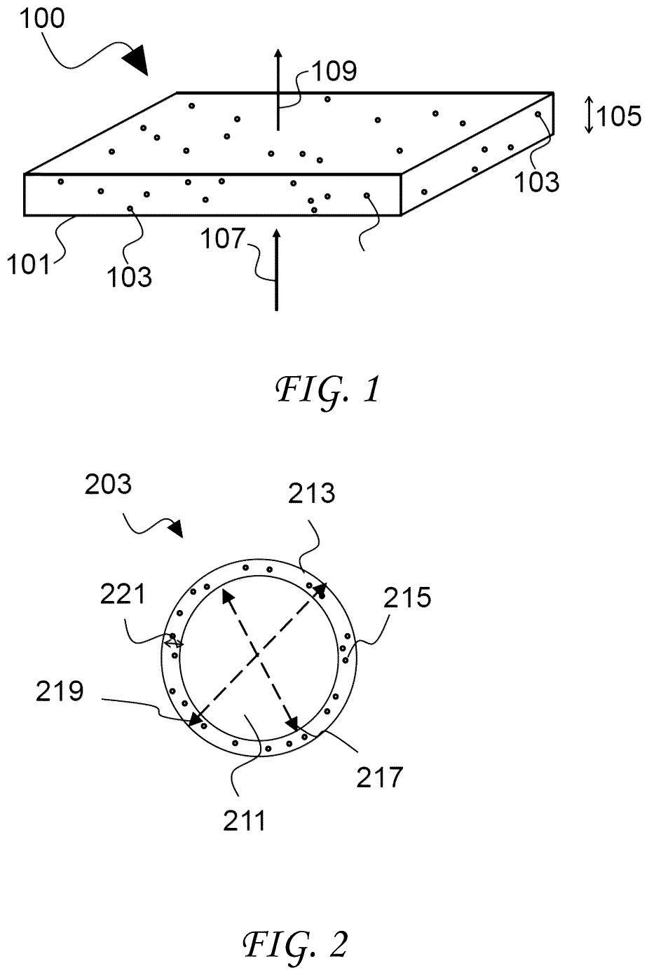

A film 100 including a plurality of structures 103 of examples herein is now described with reference to FIG. 1. The structures 103 are supported by a carrier material 101. For example, the carrier material is a material such as a resin, thermoplastic or a powder which surrounds or encapsulates the structures and in so doing supports the structures. The structures 103 include luminescent nanostructures which are configured to absorb light 107 and to emit light 109. The structures 103 may be of the type illustrated in FIG. 2 or FIG. 3, for example, and may in some examples be a mixture of these two structure types. The film may be referred to herein as a quantum dot enhancement film (QDEF).

The structure and composition according to examples herein provide protection from, for example, moisture and/or air, which may otherwise adversely affect the structural and/or optical properties of the nanostructure. This protection is available throughout handling and manufacturing of the film. In some examples, the structures can be incorporated into films comprising cured resin substrates. In some examples, the structures can be incorporated into films 100 formed from thermoplastic substrates 101 such as polystyrene. Other suitable thermoplastics include polymethylmethacrylate, polyethylene terephthalate, polypropylene, polycarbonate, polyimides, polyvinylchloride. Such thermoplastic materials may be porous, lightweight, and/or extrudable, and these can be used due to the presence of the barrier or coating in structures of examples. The structures therefore offer the potential to be incorporated into films with cheaper substrate materials, and/or improved film properties (e.g., lower weight, thinner film) and/or with simplified manufacturing processes. This in turn can simplify the manufacture of apparatus comprising the structures, e.g., a display device, reduce a display stack size of such apparatus, and/or where the support particles are light scattering obviate the need for separate light scattering material to be incorporated into the film or another element of the apparatus. In some examples, protective or barrier layers (which reduce exposure of the carrier to oxygen/moisture) are not included in the apparatus (e.g., the film is a so-called barrierless QDEF or xQDEF).

The film 100 of FIG. 1 may, in some examples, have a thickness 105 in the range of about 0.03 mm to about 3.0 mm, in the range of about 0.3 to about 3.0 mm, or in the range of about 0.5 mm to about 1.5 mm, suitably about 1 mm.

A composition in which structures are within a liquid carrier material can be made by mixing structures with the liquid carrier.

In some examples, a method of making a film containing such structures includes at least one of:
a) extruding a composition comprising at least one of: a plurality of the structures of any of examples herein, or a pre-cursor of the structures, within a liquid carrier material;
b) pressing a composition comprising at least one of: a plurality of the structures of any of examples herein, or a pre-cursor of the structures, within a liquid carrier material; or
c) forming the film from a composition comprising at least one of: a plurality of the structures of examples herein, or a pre-cursor of the structures, within a liquid carrier material.

In some such examples, the liquid carrier material may form the solid carrier material of the film, e.g., a molten carrier material which sets or a liquid carrier material which is cured to form a solid. In some examples, the liquid carrier material may be a solvent or other liquid which is removed on forming the solid film, and thus the extruded composition may comprise additional solid carrier material to support the structures when the solvent is removed. In some examples, the liquid carrier material may include material that forms the solid carrier material and material which is removed on formation of the solid film.

In some examples, the method may include a) mixing the structures with the carrier material; and b) extruding or pressing the resulting mixture.

In some example methods, the structures are made before integration into the film. In the following discussion, specific materials are referenced, but the skilled person will understand that other materials presented as alternatives in the foregoing disclosure can be used in place of those specified below. The assembly of the components is performed in a controllable manner via evaporation/precipitation-induced deposition of QDs/zinc thiolate onto alkoxysilanes/light-scattering particles (FIG. 1). The method comprises:
a) mixing of colloidal luminescent QDs and zinc thiolate in non-polar organic solvents (e.g., toluene, chloroform) to form a homogeneous system of QDs/zinc thiolate (Mixture I)
b) mixing of alkoxysilanes and light-scattering particles in non-polar/polar organic solvents to form heterogeneous system of alkoxysilanes/light-scattering particles (Mixture II)
c) assembly of multiple components into hydrophobic beads by combining Mixture I and Mixture II with subsequent deposition of QDs and zinc thiolate on alkoxysilanes/light-scattering particles by solvent evaporation or controlled diffusion of non-solvent (precipitation).

In other examples, the structures are synthesised during integration into a film containing the structures. In some examples, the method comprises:
mixing of luminescent nanostructures and one or more pre-cursor for the coating to form a first mixture
mixing one or more pre-cursor for the coating, support particles and a carrier material into the first mixture to form a second mixture;
extruding or pressing the second mixture to form a film.

In the following example, specific materials are referenced, but the skilled person will understand that other materials presented as alternatives in the foregoing disclosure can be used in place of those specified below. The assembly of the components is performed in a controllable manner via evaporation/precipitation-induced deposition of QDs/zinc thiolate onto alkoxysilanes/light-scattering particles (FIG. 1). The method comprises:
a) mixing of colloidal luminescent QDs and alkoxysilane in non-polar organic solvents (e.g., toluene, chloroform) to form a homogeneous system of QDs/alkoxysilane (Mixture I)
b) mixing zinc thiolate and thermoplastic material (e.g., polystyrene beads of diameter <5 mm) and light-scattering particles into Mixture I (Mixture II)
c) extruding Mixture II to form a film alongside solvent evaporation to form structures according to examples herein embedded in a thermoplastic film.

In some examples, a method of making a film containing structures according to examples herein without support particles includes: a) mixing luminescent nanostructures and the material, or one or more pre-cursor for the material, to form a first mixture; and b) mixing a carrier material and one or more pre-cursor for the material with the first mixture, and c) extruding or pressing the resulting mixture. In some such examples, the first mixture may be provided in a solvent, which is removed after the extrusion or pressing step.

Example 1: Example 1 is a control example, included for comparative purposes. Red-and green-emitting quantum dots (QDs) were dissolved in a non-polar organic solvent and combined with polystyrene thermoplastic beads (<5 mm) and a silicone scattering medium (TOSPEARL 120 or ETERPEARL DF10A0). The QD/silicone scatter/polystyrene mixture was then compounded in a twin-screw compounder at 200 to 220° C. Following compounding, the mixture was pressed to form a 1.5 mm thick film.

In examples 2 to 6 additional additive components were included in the QD/polystyrene film to modify the composition and morphology of the environment surrounding the QD thereby affecting the QD power retention (operational lifetime) under both operational and accelerated stress testing conditions. These additives may be added to the QD or the polystyrene or both prior to compounding and extrusion as described below.

Example 2: The same procedure as described in Example 1 was followed. However, a linear alkyl alkoxy silane (for example hexyltrimethoxysilane) was added to the QD stock solution prior to combining with the polystyrene. The silane was added at concentrations of 0.1 to 1.0 wt % relative to the mass of polystyrene.

Example 3: The same procedure as described in Example 2 was followed. However, a metal thiolate (for example zinc dodecanethiolate) was added to the QD/polystyrene mixture prior to compounding/extrusion. The metal thiolate was added at concentrations of 0.5 to 5.0 wt % relative to the mass of polystyrene.

Example 4: The same procedure as described in Example 1 was followed. However, a metal thiolate (for example zinc dodecanethiolate) was combined with the QD/polystyrene mixture prior to compounding/extrusion. The metal thiolate was added at concentrations of 0.5 to 5.0 wt % relative to the mass of polystyrene.

Example 5: The same procedure as described in Example 4 was followed. However a binder/catalyst (for example tetrabutylammonium chloride) was combined with the QD/polystyrene mixture prior to compounding/extrusion. The binder/catalyst encourages the attachment of the QD/hydrophobic medium to the surface of the silicone scattering media and was added at a concentration of 0.05 to 1.0 wt % relative to the mass of polystyrene.

Example 6: The same procedure as described in Example 5 was followed. However, a linear alkyl alkoxy silane (for example hexyltrimethoxysilane) was added to the QD stock solution prior to combining with the polystyrene. The silane was added at concentrations of 0.1 to 1.0 wt % relative to the mass of polystyrene.

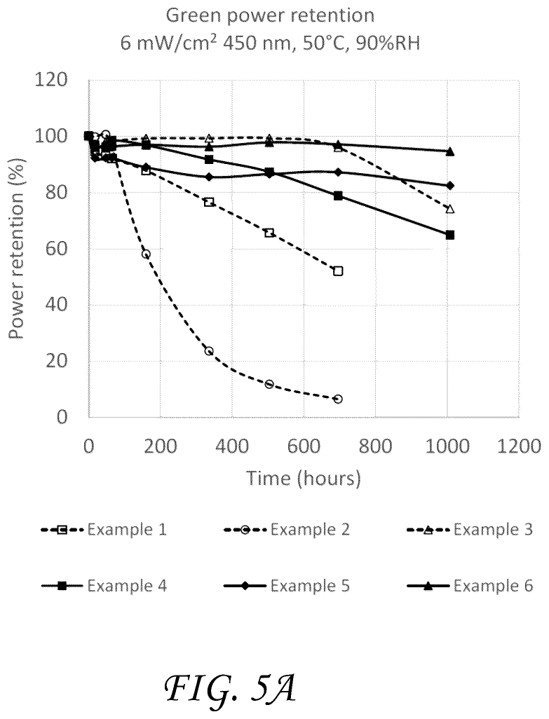

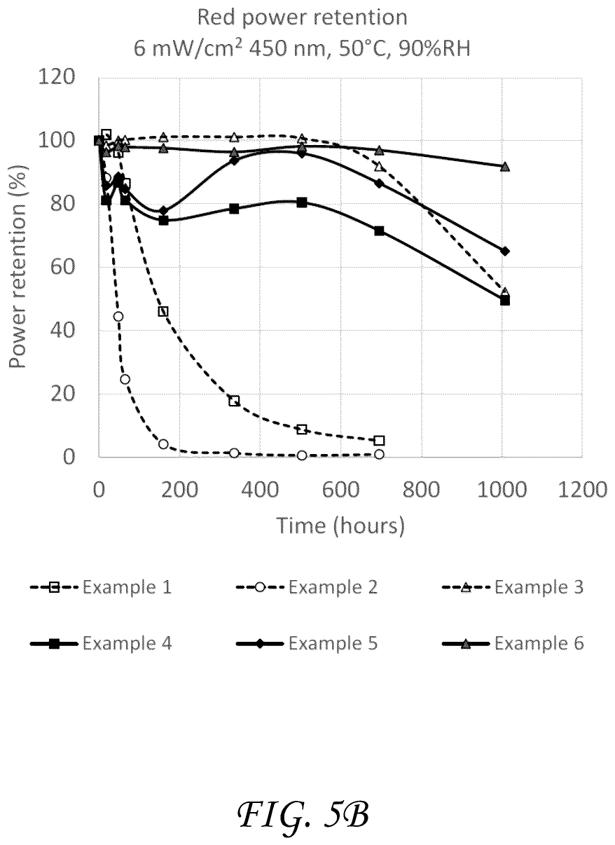

Performance retention over time under stress conditions (6mW/cm² (milli Watts per centimeter²) excitation flux at 450 nm, 50° C. (Celsius) and 90% relative humidity (RH)) is shown in FIG. 5A for the green-emitting QDs, and in FIG. 5B for the red-emitting QD.

Power retention for example 2 is less than for the control example (example 1), but the structures of example 2 do reduce aggregation of the luminescent nanostructures. It can be seen that the power retention for examples 3 to 6 is improved relative to the control example (example 1). Example 6 offers better performance.

In examples 7-9, the procedure of Example 3 was followed. However, in examples 8 and 9, sodium dodecyl sulfate (surfactant) was added to the QD stock solution prior to combining with the polystyrene.

TABLE 1
In this table, ZnDDT = zinc dodecanethiolate; HTMS =
hexyltrimethoxysilane; SDS = sodium dodecyl sulfate;
wt % given relative to the mass of polystyrene; BFE - film
brightness - proportion of blue photons (380-484 nm wavelength)
absorbed by film that are emitted as red or green photons
(484-70 nm wavelength), measured as a single-pass measurement
by a spectrometer on a QD-containing film with blue light
excitation by a diffused 450 nm LED light source.

| | | Silicone | | | |
|---|---|---|---|---|---|
| | | support | | | |
| | ZnDDT | particles | HTMS | SDS | BFE |
| | (wt %) | (wt %) | (wt %) | (wt %) | (%) |
| Example 7 | 1.0 | 1.0 | 0.3 | 0.0 | 49.4 |
| Example 8 | 1.0 | 1.0 | 0.3 | 0.5 | 62.4 |
| Example 9 | 1.0 | 1.0 | 0.3 | 1.0 | 62.0 |

Emission brightness of the resultant film is improved by inclusion of the surfactant when forming the silanized coordination polymer on the support particles.

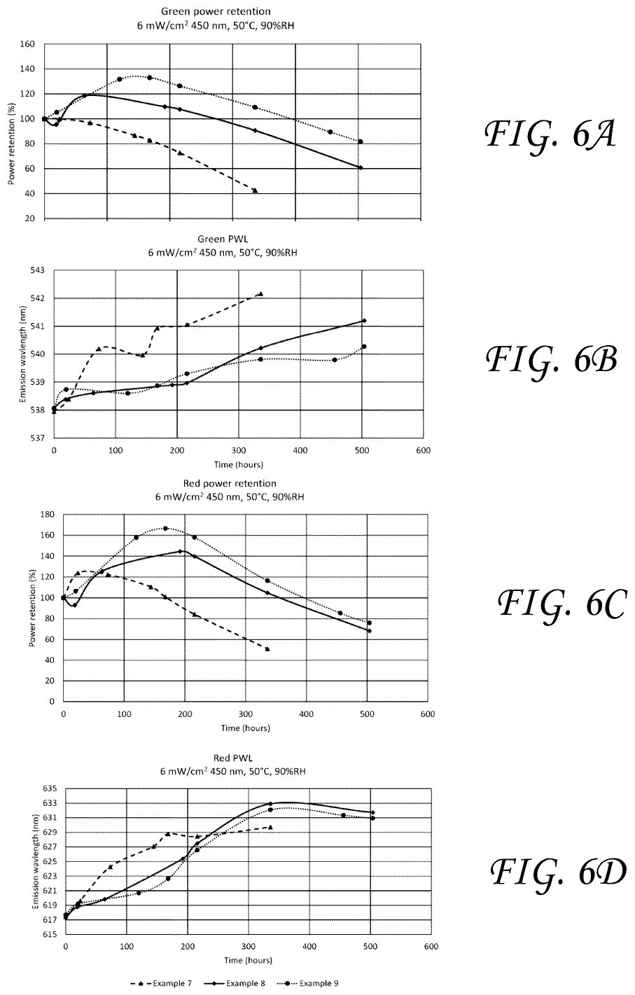

Performance retention and stability of the emission wavelength (PWL) over time under stress conditions (6 mW/cm² excitation flux at 450 nm, 50° C. and 90% RH) are shown in FIGS. 6A and 6B for the green-emitting QDs, and in FIGS. 6C and 6D for the red-emitting QD.

In examples, an apparatus comprises a composition as described previously, e.g., a film or a plurality of structures within a carrier material. Such apparatus may comprise a light source configured to emit light of one or more wavelength absorbed by the nanostructures. In some examples there is also a filter array comprising red light filters for transmitting red light, green light filters for transmitting green light, and blue light filters for transmitting blue light; and a light valve array. In other such examples the light source is a light emitting diode comprising the composition or film, e.g., as a layer (e.g., uppermost layer) of the light emitting diode located to receive light generated by the light emitting diode and output light from the nanostructures onwards. In this way each light source may be configured with the composition or film. Another apparatus with each light source having a corresponding film or composition of examples described herein is for example an array or plurality of the composition or film each positioned to receive light emitted from a respective light source of a plurality of the light sources. Such a plurality or array is, e.g., provided as a layer separate from the light sources, and may be ink jet printed.

Further details of such apparatus will now be elaborated in more detail below.

In examples described herein, compositions are provided which comprise (a) a carrier matrix, (b) a plurality of photoluminescent nanostructures distributed within the carrier matrix, (c) a secondary antioxidant compound dispersed in the carrier matrix and configured to decompose one or more hydroperoxides, and (d) a supplementary base dispersed in the carrier matrix.

As the skilled artisan will appreciate, a secondary antioxidant is a compound which, for example, reacts with hydroperoxides to form inactive alcohol products. Secondary antioxidants include trivalent phosphorus compounds, thioethers and organic sulfides, for example. Reference to a secondary antioxidant being present does not imply that a primary antioxidant is also present; use of the term ‘secondary’ in this context is understood by the skilled artisan as relating to the function of the antioxidant in question.

Extruded structures containing quantum dots (QDs) have the potential to significantly reduce the cost of utilizing QDs in display applications (as compared to cast film systems). However, process conditions during extrusion can be more deleterious and more likely to compromise QD performance than conditions used during film production. As such, mitigating extrusion-related damage could potentially improve extruded QD composites to match or exceed the performance of QD-laminate film structures.

Dispersed and/or dissolved in the carrier matrix as a stabilizing additive, the secondary antioxidant compound may consume reactive species generated during extrusion, and so at least partly prevent these reactive species from reacting with the QD, to help preserve the QD performance. Primary antioxidants (which react with free radicals) have been found in some cases to negatively impact QD performance in an extruded composite. Thus, in some examples the compositions include no primary antioxidant.

In some examples the secondary antioxidant compound comprises phosphorus. In some examples the secondary antioxidant compound comprises a phosphonate or phosphaspiro group.

In some examples the composition comprises 0.01 wt % to 10 wt % of the secondary antioxidant compound on a dry weight basis (e.g., solvents are not included in 100 wt %). In some examples the composition includes up to about 1 wt % of the secondary antioxidant compound.

In some examples the secondary antioxidant compound has the structure A−[(L) ₙ−R]ₘ, wherein A is a moiety with secondary antioxidant functionality; each L is a linker group selected from phenyl, —O— and —S—; n is selected from 0 or 1; each R is independently a C₆₋₄₀ hydrocarbon group which may be substituted; and m is a number from 1 through 6, inclusively.

In some examples each R may be substituted by one or more halo or hydroxy substituents. Each R may be linear or branched. Each R may comprise unsaturated bonds, such as 1 or 2 unsaturated bonds. In some examples herein, each R is a linear, saturated alkyl group.

In some examples herein A is 2,4,8,10-tetraoxa-3,9-diphosphaspiro[5.5]undecane. In some examples n is 0 and m is 2. In some examples the secondary antioxidant compound is 3,9-bis(octadecyloxy)-2,4,8,10-tetraoxa-3,9-diphosphaspiro[5.5]undecane (DSPP).

Without tying this disclosure to any particular theory, it is thought that the R groups may bind to a ligand corona on the surface of the luminescent nanostructures, for example by Van der Waals forces. Such binding localises the secondary antioxidant at the surfaces of the nanostructures, improving retention of QD performance relative to other antioxidants, as demonstrated in the examples below.

In some examples the composition may additionally comprise light scattering particles, substantially formed from (e.g., entirely comprising within acceptable purity tolerances) a material for scattering light, e.g., light of a wavelength absorbed by the nanostructures and/or light of a wavelength emitted by the luminescent nanostructures. This light scattering property, e.g., increases the effective path length in proximity to the luminescent nanostructures, thereby increasing coincidence of excitation photons with the nanostructures and increasing down-conversion efficiency. In some such examples the material forming the light scattering particles has a band gap of greater than about 3 electron volts (eV). In some examples the light scattering particles comprise an inorganic material. And, in some examples, the light scattering particles may comprise a metal oxide or sulfide, e.g., one or more of silicon dioxide (SiO₂), titanium dioxide (TiO₂), zinc oxide (ZnO) or zinc sulfide (ZnS).

In some examples the composition may additionally comprise an alkylalkoxysilane and a coordination polymer. An alkylalkoxysilane is an alkoxysilane with a linear or branched alkyl substituent, such as hexyltrimethoxysilane (HTMS). In some cases the alkylalkoxysilane exhibits a boiling point >200° C., such as dodecyltrimethoxysilane or dodecyltriethoxysilane. A coordination polymer may be an inorganic or organometallic polymer structure containing metal cation centres linked by ligands, such as a metal thiolate, e.g., zinc dodecanethiolate (ZnDDT). The alkylalkoxysilane and the coordination polymer (e.g., metal thiolate) may form a silanized coordination polymer, which may be water repellent. The presence of the silanized coordination polymer may thereby increase resistance to water-initiated degradation of the nanostructure performance.

Judicious alkylalkoxysilane selection provides practical as well as performance advantages. Some alkylalkoxysilanes are more volatile than others (for example, hexyltrimethoxysilane has a boiling point of ˜200° C., whereas the two additional compounds listed above have higher boiling points (dodecyltrimethoxysilane b.p. ˜280° C.; dodecyltriethoxysilane b.p. ˜330° C.). Since the compounding and extrusion of QD thermoplastic plates in polystyrene occurs at ˜220° C., a less volatile silane may offer advantages in terms of (1) yield and effectiveness, since it is more likely to remain within the QD thermoplastic plate and (2) reduced evaporation into the local atmosphere.

In some examples the composition comprises a silanized coordination polymer, which is the reaction product of an alkylalkoxy silane and a coordination polymer (e.g., a metal thiolate), and, in some examples a silanized coordination polymer, which is the reaction product of a linear alkylalkoxy silane and a metal thiolate. In some examples the silanized coordination polymer may be formed from an alkylalkoxysilane and a metal thiolate, with a weight ratio of alkylalkoxysilane to metal thiolate of approximately 1:5. In some examples the silanized coordination polymer may be formed from hexyltrimethoxysilane and zinc dodecanethiolate.

In some examples the silanized coordination polymer may be the reaction product of an alkylalkoxy silane and a metal thiolate in the presence of a surfactant. In some such examples the surfactant may be an anionic surfactant, which may contain a sulfate, sulfonate, phosphate and/or carboxylate group. In some particular examples the anionic surfactant may be an alkyl sulfate such as ammonium dodecyl sulfate and sodium dodecyl sulfate, or an alkyl-ether sulfate such as sodium laureth sulfate or sodium myreth sulfate. In some particular examples the anionic surfactant may be sodium dodecyl sulfate. In some particular examples the anionic surfactant may be a metal carboxylate. In some particular examples the metal carboxylates may comprise a lithium salt of a fatty acid. Non-limiting examples of lithium salts of fatty acids include lithium stearate, lithium oleate and lithium palmitate. The presence of a surfactant during the reaction of an alkylalkoxy silane and a metal thiolate may in some examples improve the emission brightness, the emission power retention and/or the stability of the emission wavelength over time.

In some examples the composition may additionally comprise a hindered amine light stabiliser (HALS) as a stabilizing additive. As the skilled artisan will understand, hindered amine light stabilisers are, for example, compounds which may be mixed into polymers (including plastics) and contain an amine functional group. The amine group is for example hindered so as to reduce or minimise side reactions or conversion of the HALS into nitrone species; for example, the hindered amine may in some instances possess no alpha hydrogens, so as to reduce or minimise conversion into a nitrone. A HALS may at least partially prevent photo-oxidation, and possibly other forms of polymer degradation, such as ozonolysis. HALSs do not generally absorb ultraviolet (UV) radiation but act to inhibit degradation of the polymer by continuously and cyclically removing free radicals that are produced by photo-oxidation of the polymer. The overall process is sometimes referred to as the Denisov cycle. Broadly, a HALS may react with the initial polymer peroxy radical (ROO⋅) or alkyl polymer radicals (R⋅) formed by the reaction of the polymer and oxygen, to at least partially prevent further radical oxidation. By these reactions HALS are oxidised to their corresponding aminoxyl radicals, but return to their initial amine form via a series of additional radical reactions.

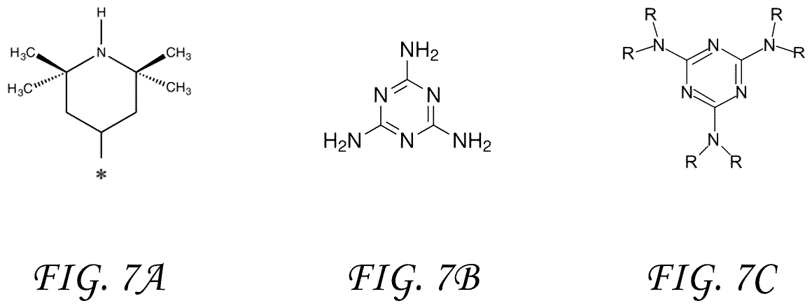

In some examples a HALS may comprise 2,2,6,6-tetramethylpiperidin-4-yl: FIG. 7A shows the molecular structure of 2,2,6,6-tetramethylpiperidin-4-yl, a hindered amine light stabiliser, where the asterisk indicates the point of attachment to the rest of the compound structure. It will be noted that a HALS comprising a piperidine moieties may be resistant to intramolecular Cope reactions.

Moreover, it is observed that the two new HALS compounds which disclosed herein may offer an improvement over the pre-existing HALS compound-both by itself and in combination with the pre-existing compound. By inference, one HALS compound may be better than another in a given formulation due to (1) thermal stability, (2) synergism with other formulation components, (3) resistance to deactivation by acids or other chemical antagonists, or (4) dispersion and migration within the thermoplastic article. Plural, related HALS compounds may be used in combination with each other to provide the improved stabilization, due to complementary pathways to oxidant deactivation.

In some examples the HALS comprises a polymer backbone, and the 2,2,6,6-tetramethylpipidin-4-yl, for example, is attached to the polymer backbone within the repeating unit of the polymer. In some such examples the HALS may comprise poly[[6-[(1,1,3,3-tetramethylbutyl)amino]-1,3,5-triazine-2,4-diyl] [(2,2,6,6-tetramethyl-4-piperidinyl)imino]-1,6-hexanediyl[(2,2,6,6-tetramethyl-4-piperidinyl)imino]]) which may, in some particular examples, have a molecular weight in the range of about 2000 and 3100 grams per mole (g/mol). In some such examples the HALS may comprise 1,6-hexanediamine, N,N′-bis (2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine which may, in some particular examples, have a molecular weight in the range of 2600 and 3400 grams per mole (g/mol). In some such examples the HALS may comprise poly (4-hydroxy-2,2,6,6-tetramethyl-1-piperidineethanol-alt-1,4-butanedioic acid) which may, in some particular examples, have a molecular weight in the range of 3100 and 4000 grams per mole (g/mol). In some examples the luminescent nanostructures are quantum dots.

The secondary antioxidant compound and the luminescent nanostructures are dispersed in a carrier matrix—i.e., ‘carrier’. In some examples the carrier comprises a thermoplastic material or a precursor to the thermoplastic material. In some cases, the carrier material comprises polystyrene.

In some examples the carrier comprises a liquid, such as a solvent. In such cases, the composition behaves as a liquid (e.g., a liquid or a suspension of solid particles in a liquid). The liquid carrier may be at least partially removed from the composition prior to or during extrusion. In some examples, the carrier may comprise heptane.

In some examples, there is provided a solid structure comprising the composition described herein. The structure may be formed by a process comprising extrusion. In some cases, the structure is wholly or substantially planar and may be referred to as a plate, layer, film or the like. In some examples ‘substantially planar’ indicates that the thickness of the structure is less than about 5% of the width and length, such as less than about 1%. In some examples ‘substantially planar’ indicates that the structure thickness is entirely within about 10% of the mean thickness, such as mean ±5%. The planar structure may have a thickness in the range of about 0.03 millimeters (mm) to about 3.0 mm.

According to some examples the composition herein may be provided as a solid, substantially planar structure, which could alternatively be described as a plate, film, layer or the like. In some examples this may be formulated by mixing components of the composition alongside a liquid carrier (such as a solvent), drying to remove solvent, and extruding the composition. Some examples may include the subsequent steps of heating to dry the extruded composition (e.g., solvent removal) and/or curing components of the composition by light exposure or heating.

In some examples a separate barrier film (e.g., in a so-called quantum-dot enhancement film (QDEF)) need not be applied as the nanostructures are protected from moisture and/or air by the secondary antioxidant compound and/or supplementary base.

Examples will now be described with reference to the figures and comparative examples herein. In the following examples and comparative examples, the following dry powders were mixed: polystyrene, SiO₂ particles (light scattering particles), zinc dodecanethiolate, hexyltrimethoxysilane, Chimassorb® 944 (a product of BASF of Ludwigshafen, Germany) and an antioxidant compound, where present. Quantum dots suspended in heptane were then added to the powder mix, and the solvent was allowed to evaporate. The resulting mixture was extruded to form plates, which were subject to testing.

Chimassorb® 944 is a HALS, which is poly[[6-[(1,1,3,3-tetramethylbutyl)amino]-1,3,5-triazine-2,4-diyl] [(2,2,6,6-tetramethyl-4-piperidinyl)imino]-1,6-hexanediyl[(2,2,6,6-tetramethyl-4-piperidinyl)imino]]).

### Comparative Example 1

In this comparative example, no antioxidant was included.

### Example 1

In this example 0.5 wt % of DSPP was added to the powder mixture.

The backlight film efficiency (BFE) for the plate of Example 1 was 62.1%, whereas the BFE for the plate of Comparative Example 1 was 57.5%. It will be noted that BFE is a measure of brightness and is the proportion of blue photons (380 to 484 nm wavelength) absorbed by the plate that are emitted as red or green photons (484 to 780 nm wavelength), measured as a single-pass measurement by a spectrometer on a QD-containing plate with blue light excitation excited by a diffused 450 nm LED light source.

### Comparative Examples 2A-D

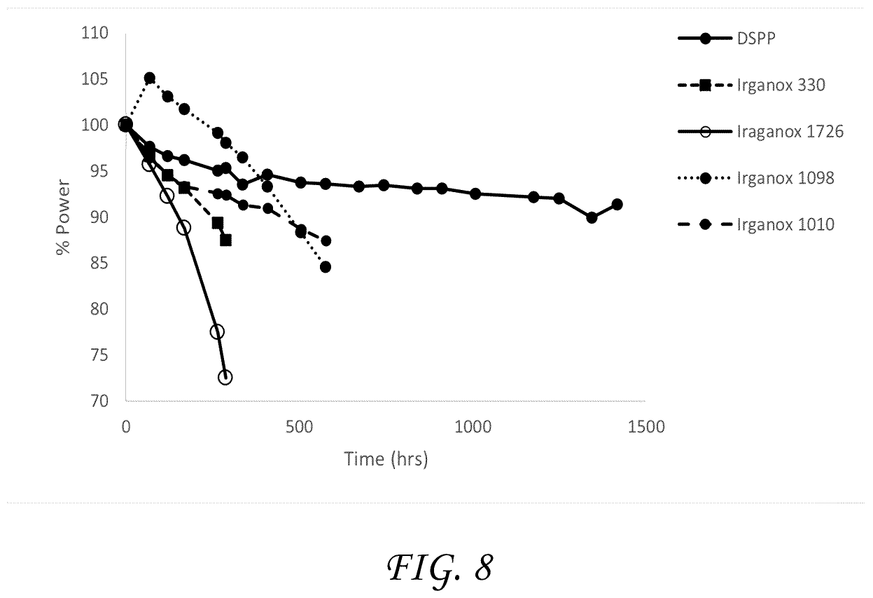

In these comparative tests, a series of primary antioxidants were included in the extruded composition. FIG. 8 shows green QD power retention for Comparative Examples 2A-D and for Example 1. It can be seen that power retention was significantly improved on addition of DSPP as compared to the primary antioxidants under test conditions (flux 6 mW/cm² at 50° C. and 90% relative humidity).

FIG. 8 illustrates the impact of addition of DSPP to compositions of the comparative examples. Each was prepared as outlined above.

TABLE 2
Performance data for luminescent nanostructures within compositions of examples and comparative examples.

| | | | | | | | Green full | | Red full |
|---|---|---|---|---|---|---|---|---|---|
| | | | | | | | width at | | width at |
| | | | | | | Green | half | Red | half |
| | | | | | | emission | maximum | emission | maximum |
| | HTMS | ZnDDT | Chimassorb | DSPP | BFE | wavelength | (FWHM) | wavelength | (FWHM) |
| Formulation | (wt %) | (wt %) | 944 (wt %) | (wt %) | (%) | (nm) | (nm) | (nm) | (nm) |
| ZnDDT + | 0.33 | 1.0 | — | — | 51.9 | 538.1 | 21.4 | 626.8 | 26.1 |
| Silane | | | | | | | | | |
| HALS + Silane | 0.33 | — | 0.80 | — | 55.8 | 538.9 | 21.5 | 629.9 | 26.4 |
| ZnDDT + | 0.33 | 1.0 | 0.80 | — | 60.3 | 538.4 | 21.5 | 627.6 | 25.3 |
| Silane + HALS | | | | | | | | | |
| ZnDDT + | 0.33 | 1.0 | 0.80 | 0.50 | 62.1 | 538.3 | 21.4 | 627.5 | 25.7 |
| Silane + | | | | | | | | | |
| HALS + DSPP | | | | | | | | | |

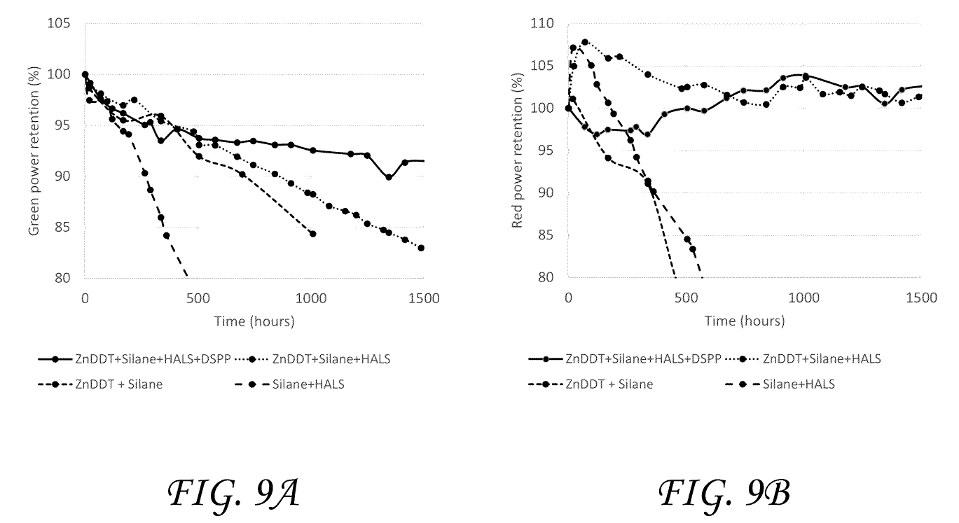

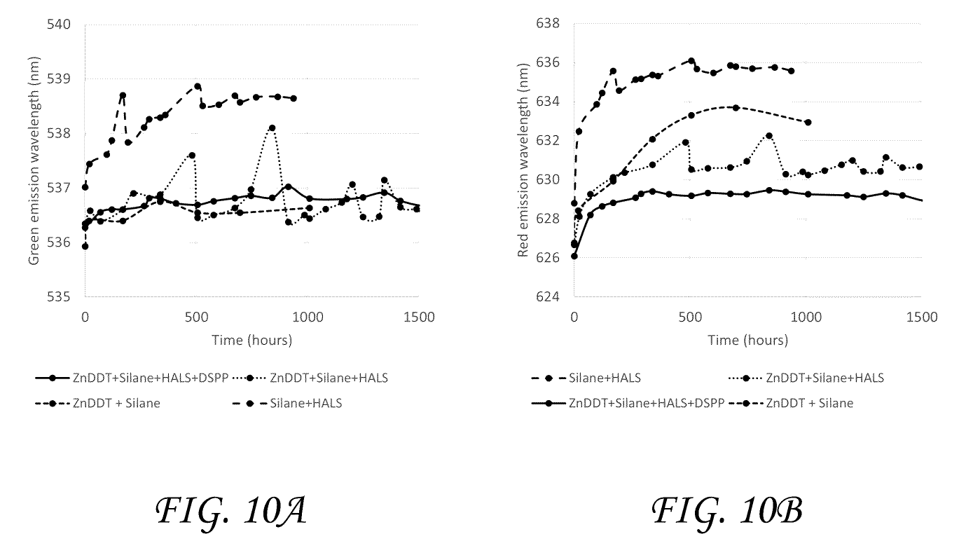

Table 2 and FIGS. 9A, 9B, 10A, and 10B detail other formulations which have been tested at a flux of 6 mW/cm² at 50° C. and 90% relative humidity. The fourth composition has a higher backlight film efficiency than the other compositions.

FIGS. 9A and 3B illustrate that the fourth composition from Table 2 has better green QD power retention and significant red QD power retention.

FIGS. 10A and 10B illustrate that the fourth composition from Table 2 has significant emission wavelength stability for both green-emitting QDs (FIG. 4A) and red-emitting QDs (FIG. 4B)

Quantum-dots-in-polymer nanocomposites (e.g., barrierless QDEF, QD thermoplastic plates, etc.) present a novel class of bright and narrow-emitting materials for display applications. To improve the stability of QD properties in these composites towards photooxidation, complex additive combinations with different functions (chain-breaking antioxidants, peroxide decomposers, photostabilizers, etc.) are developed which enhance the QD photoluminescence lifetime. This disclosure reports further improvement in QD performance via next-generation additive compositions, which stabilize QDs in the polymer matrix and provide long-term protection. Disclosed herein is a new co-additive class that shows synergetic behavior in multi-component blends, enabling further improvement in the operational lifetime of QDs in polymer matrices. These additives significantly reduce oxidation-induced degradation rates under photoexcitation in humid conditions.

Photooxidation of semiconductor light-emitting QDs, which can be catalyzed by water molecules and/or metal ions and accelerated by heat, usually leads to reactive species (e.g., peroxides and hydroxy and (alkyl)peroxy radicals). These highly reactive species photocorrode the inorganic units of the emissive material, lowering the photoluminescence quantum yields and limiting the operational lifetimes of QD optical components (QDEF, QD thermoplastic diffuser plates, etc.).

To tackle the issue of QD operational stability for barrierless QDEF and QD thermoplastic optical plates, protective agents (antioxidants) can be used. These agents inhibit the photooxidation-induced degradation of QDs. Due to the complex nature of QD photooxidation, mono and/or bi-functional antioxidants may not provide adequate protection against photooxidative degradation. The rational combination of different antioxidants with complementary functions such as chain-breaking antioxidants, peroxide decomposers, photostabilizers, and/or metal deactivators seems to be a powerful approach that could significantly improve QD performance.

Formulating efficient multi-additive blends of functional antioxidants with synergetic behavior, which protects QDs against photooxidation, is desirable for addressing the issue of QD operational stability for barrierless QDEF and QD thermoplastic optical plates. This may enable low-cost solutions for bright and narrow emitters in optical components and may expand the market share of QDs in electronic displays.

The QD anti-photooxidative efficiency of a multi-additive blend of antioxidants, which includes preventive antioxidants such as phosphorus-containing antioxidants (e.g., 3,9-bis(octadecyloxy)-2,4,8,10-tetraoxa-3,9-diphosphaspiro[5.5]undecane), S-containing antioxidants (e.g., zinc dodecanethiolate) and photostabilizers, such as hindered amine stabilizers (e.g., N,N′-bis(2,2,6,6-tetramethylpiperidin-4-yl)hexane-1,6-diamine; 2,4,6-trichloro-1,3,5-triazine; 2,4,4-trimethylpentan-2-amine) can be significantly improved by addition of a basic additive, such as 2,4,6-triamino-1,3,5-triazine (melamine). This example compound appears to show synergism to all components of the multifunctional antioxidants. FIG. 7B shows the structure of melamine, which is usable as a supplementary base. FIG. 7C shows the structure of an example substituted melamine, which also may be usable as a supplementary base. In the illustrated structure, each R may comprise a hydrogen atom or an alkyl or aryl group. The R groups may be mutually equivalent in some examples and may differ in other examples. Any, some, or all of the R groups may be selected to as to enhance dispersibility of the secondary amine compound in the carrier matrix.

Melamine can act as a basic protector of antioxidants and/or QDs against in-situ generated acids that can otherwise deactivate the stabilization functions of hindered amine stabilizers (via deactivation of a piperidinyl moiety, for instance) or of phosphorus and/or sulfur-containing antioxidants (via catalytic hydrolysis of phosphites or sulfides), or may trigger etching of light-emitting semiconductor QDs with subsequent degradation of optical properties.

Additionally, melamine is a powerful heat stabilizer that increases resistance of both QDs and antioxidants toward thermal degradation, which can be a serious issue during QD composite processing (e.g., high temperature extrusion, molding, spinning, calendering, coating) and in-use applications (e.g., barrierless QDEF or QD thermoplastic plates in displays where temperatures near the blue light source (LED or mini-LED) can approach and exceed 50° C.).

The combination of the above characteristics of melamine improves the antioxidant behavior of the multi-additive blend, enabling significant reduction of the oxidation-induced degradation rate under photoexcitation in humid conditions.

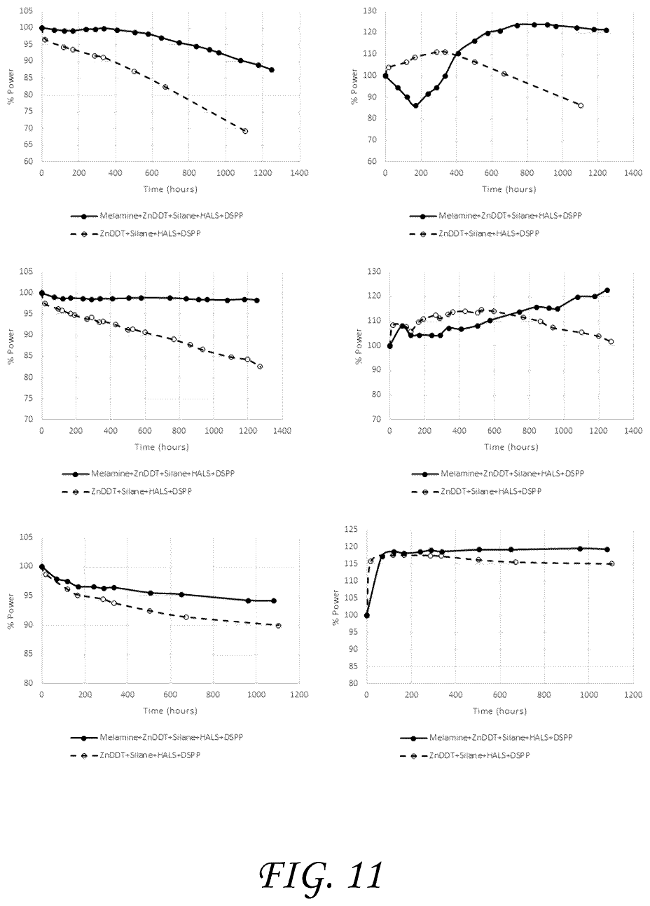

FIG. 11 shows aspects of reliability data (power versus time) for green- and red-emitting QDs under different testing conditions. The multi-additive blend includes 1.5 wt % of N,N′-bis(2,2,6,6-tetramethylpiperidin-4-yl)hexane-1,6-diamine; 2,4,6-trichloro-1,3,5-triazine; 2,4,4-trimethylpentan-2-amine; 1.5 wt % of zinc dodecanethiolate; 0.5 wt % of 3,9-bis(octadecyloxy)-2,4,8,10-tetraoxa-3,9-diphosphaspiro[5.5]undecane; 0.2 wt % of hexyltrimethoxysilane; with and without 0.65 wt % of melamine. Conditions in the first row of FIG. 11 are 16 mW/cm², 60° C., and 90% relative humidity. Conditions in the second row are 6 mW/cm², 50° C., and 90% relative humidity. Conditions in the third row are 50 mW/cm² and 50° C. with ambient relative humidity.

The antioxidant blends herein comprise at least one supplementary base. Each supplementary base can be a Brønsted base or a Lewis base. In some examples the Brønsted base may be a metal carbonate. In some particular examples the Brønsted base may be a lithium carbonate.

The supplementary base may be an aromatic or aliphatic amine, which can be saturated, unsaturated, bridged, cyclic or open-chain, straight or branched, with or without rings of any type. The amines can be primary, secondary or tertiary. The amines can be polymeric, oligomeric, monomeric or of low-molecular weight. In some examples the supplementary base may be a Mannich compound—i.e., a product of a Mannich condensation.

The supplementary base may be thermally stable, with nitrogen-containing heterocycles and with amine-based functional group(s).

The supplementary base may be a triazine or triazine-derivative (including a triazine isomer) containing one or more amine-based functional groups. In some examples the supplementary base may comprise an aromatic imine base.

The supplementary base may comprise melamine (2,4,6-triamino-1,3,5-triazine) or a melamine derivative.

TABLE 3
Amount of antioxidant additives in polystyrene/QD carrier plates and their corresponding optical properties.

| | | | | | | | | Green full | | Red full |
|---|---|---|---|---|---|---|---|---|---|---|
| | | | | | | | | width at | | width at |
| | | | Chimassorb | | | | Green | half max | Red | half max |
| | HTMS | ZnDDT | 944 | DSSP | melamine | BFE | emission | (FWHM) | emission | (FWHM) |
| Formulation | (wt %) | (wt %) | (wt %) | (wt %) | (wt %) | (%) | λ (nm) | (nm) | λ (nm) | (nm) |
| w/ | 0.2 | 1.5 | 1.5 | 0.5 | 0.65 | 61.5 | 539.9 | 24.2 | 617.3 | 23.7 |
| melamine | | | | | | | | | | |
| w/o | 0.2 | 1.5 | 1.5 | 0.5 | — | 61.4 | 540.3 | 24.3 | 617.1 | 23.8 |
| melamine | | | | | | | | | | |

In some examples, a composition according to the present disclosure may comprise a plurality of heterogeneous domains distributed within the carrier matrix. The average size of a heterogeneous domain is not particularly limited, but may range from tens of nanometers to tens of micrometers, for example. In compositions that comprise heterogeneous domains, at least one of the photoluminescent nanostructures and at least one of the stabilizing additives may be distributed together as heterogeneous domains within the carrier matrix such that the photoluminescent nanostructures are in direct contact with the stabilizing additives. Example stabilizing additives include one or more hindered amine stabilizer(s), one or more alkylalkoxysilane(s) and coordination polymer(s), one or more silanized coordination polymer(s), and one or more secondary antioxidant(s). The sub-combinations among these variants are all envisaged. In this manner, the photoluminescent nanostructures may be arranged in contact with any, some, or all of the agents that stabilize their emission performance.

In some examples, an apparatus comprises a composition as described previously, e.g., a planar structure (e.g., a plate, film, or layer) formed from the composition. Such apparatus may comprise a light source configured to emit light of one or more wavelengths absorbed by the nanostructures. In some examples there is also a filter array comprising red light filters for transmitting red light, green light filters for transmitting green light, and blue light filters for transmitting blue light; and a light valve array. In other such examples the light source is a light emitting diode comprising the composition or film, e.g., as a layer (e.g., uppermost layer) of the light emitting diode located to receive light generated by the light emitting diode and output light from the nanostructures onwards. In this way each light source may be configured with the composition or film. Another apparatus with each light source having a corresponding film or composition is, for example, an array or plurality of the composition or film each positioned to receive light emitted from a respective light source of a plurality of the light sources. Such a plurality or array is, e.g., provided as a layer separate from the light sources, and may be ink-jet printed. Further details of such apparatus will now be described in more detail below.

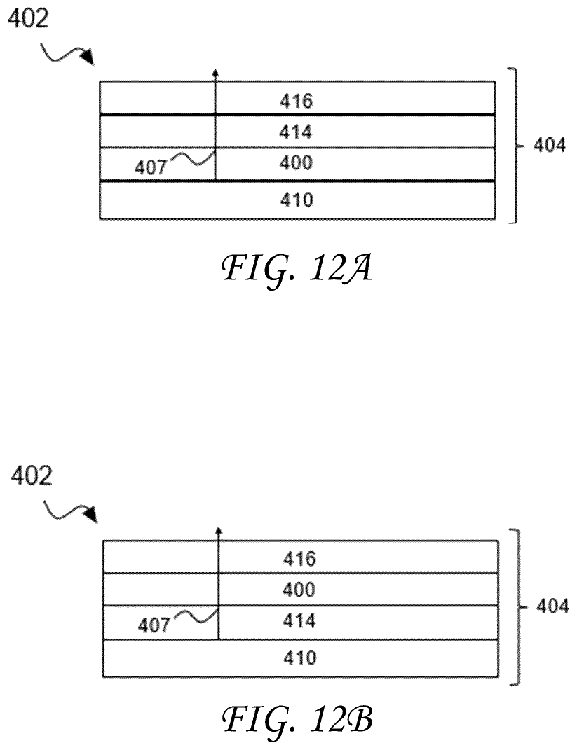

Apparatus consonant with the disclosure is now described with reference to FIGS. 12A and 12B. The apparatus illustrated schematically in FIGS. 5A and 5B is a display device 402 which has functional elements which are configured to operate together to generate and output an image. Some such functional elements are stacked and referred to collectively as a display stack 404. The display stack 404, e.g., has a light source 410 configured to emit light 407 (e.g., a light emitting diode (LED) or organic LED (OLED) backlight), a light valve array 414 (e.g., a liquid crystal display (LCD) panel) for modulating an amount of light received from the light source, and a filter array 416 (e.g., a colour filter array such as a red, green and blue sub-pixel filter array) for determining the colour of light output by the display device 402 (e.g., by each sub-pixel region of the device). A plate 400 according to examples may be arranged between the light source 410 and the light valve array 414 (as illustrated in FIG. 6A), or may be located between the light valve array 414 and the filter array 416 (as illustrated in FIG. 6B, for example).

The display device 402 has a light source 410 positioned, e.g., to provide a back-lit or edge-lit display device. The light source is, e.g., at least one of: an LED, an LED array, an organic LED (OLED), an OLED array, a laser, a laser array, or a lamp. The light source may be configured for illuminating multiple picture elements of the display device or there may be a multitude of light sources with each illuminating a single picture element. A picture element is, e.g., a sub-pixel or pixel of a display device. A display device typically comprises a plurality of picture elements independently controllable for the display device to display an image. The picture elements are arranged according to a pattern, e.g., as an array, matrix or grid, as the skilled person understands. A display device capable of displaying a colour image typically has a plurality of pixels, with each pixel comprising a plurality of sub-pixels; e.g., a pixel comprises a red (R) sub-pixel, a green (G) sub-pixel and a blue (B) sub-pixel which together function as an RGB pixel. There may be additional, independently controllable, sub-pixels, e.g., a white (W) sub-pixel, to give an RGBW pixel.

In addition to such a light source, a display device comprises a light modulator configured to modulate light emitted by the light source, for displaying an image. The light modulator has an array of light modulator regions to modulate light. Each light modulator region of the array of light modulator regions corresponds to a respective picture element of the display device. So, for example, when viewing a viewing side of the display device for displaying an image to a user's eye, a perimeter of one light-modulator region determines an extent of one picture element. The light source or light guide has an extent covered by the array of light modulator regions, so that each light modulator region can be illuminated by the light source. The light valve array 414 described previously is an example of such a light modulator.

A display device control system (not illustrated) is configured to control the array of light modulator regions for the display device to output an image. Each light modulator region is independently controllable, to modulate the amount of light transmitted through the modulator region to the viewing side, for each picture element. Thus one light modulator region may be switched to transmit less light (a darker state) than another light modulator region (a lighter state), so that with appropriate light modulation across the array of light modulator regions (and therefore the picture elements) the display device can display a desired image.

As the skilled artisan understands, one type of light modulator uses liquid crystal (LC) molecules for light modulation. By applying an electric field of appropriate magnitude to electrodes of a light modulator region, an orientation of the LC molecules can be changed to modulate light output by a respective picture element, for displaying an image on a viewing side. An LC type light modulator has a polarizer layer to linearly polarize light input to the light modulator. The polarizing layer is on a substrate (e.g., glass). There is a circuitry layer on the substrate, connected to an array of electrodes (e.g., of indium tin oxide (ITO)), each of which is electrically insulated from each other and has an extent which determines a shape and size of each picture element. On the electrodes there is a layer comprising LC molecules, the LC molecules and their density in the layer is selected to provide a required rotation of linearly polarized light in accordance with a magnitude of applied electric field. An alignment layer is in contact with the layer comprising LC molecules, to align the LC molecules in contact with the alignment layer with a particular orientation. There is another linear polarizer layer, for polarizing light exiting the light modulator, orientated to linearly polarize light at an orientation, e.g., perpendicular to the polarizer layer described above. On the another linear polarizer layer is a substrate (e.g., of glass). There is an electrode with an extent to cover more than one (e.g., all) picture elements, which may be referred to as a common electrode.

Each picture element also comprises a colour filter, in these examples, between the alignment layer and another linear polarizer layer. By appropriate choice of the colour filter for each picture element, an RGB pixel (of three sub-pixel picture elements) can be made with red filters to transmit red light, e.g., of a 630 nanometre wavelength, green filters to transmit green light, e.g., of a 532 nanometre wavelength, and blue filters to transmit blue light, e.g., of a 467 nanometre wavelength. An array of such colour filters is an example of the filter array described previously.

The display device has a display stack of functional elements including for example the light source, the QDEF, and the filter array. In these examples there is also the light modulator, and starting from the lowest layer of the stack, there is a substrate (e.g., of glass), a light source circuitry layer on the substrate, and a plurality of LEDs as the light source connected to the circuitry layer. In a back-lit example, the plurality of LEDs is configured and positioned, e.g., as an array of LEDs overlapped by the light modulator, to illuminate the light modulator.

The density and positioning of the LEDs depends at least partly on the shape and size of the picture elements of the display, but also the illumination characteristics of each LED and any layers such as a diffuser or reflector for transmitting light from the LEDs to the light modulator. In some such examples each LED of the plurality of LEDs of the illumination device is configured to illuminate a plurality of picture elements (e.g., 50 to 100 or several thousands) of the display device. Each plurality of picture elements can be considered a zone, with a so-called mini-LED configuration, with each zone in some examples being independently controllable compared with other zones. Switching different zones differently can improve contrast, e.g., by switching off one zone to give a darker black, and may be referred to as ‘local dimming’.

In other examples, which are edge-lit, instead of the array of LEDs there is a light guide overlapped by the light modulator and at least one LED of the plurality of LEDs is positioned along at least part of a perimeter of the light guide, to illuminate the light modulator via the light guide. In some such examples, or other examples, there is a light diffuser overlapped by the light modulator.

Between the LEDs and the light modulator may be one or more layer, e.g., a diffuser to distribute light from the LEDs more evenly across the light modulator, and/or alignment layer (e.g., a so-called brightness enhancement film (BEF) using, e.g., prisms to align light from the LEDs with each picture element. A plurality of diffuser and/or alignment layers of this kind may be used in some examples. Various other functional elements may be used as the skilled artisan will appreciate, for example to modify light. Examples include a so-called ‘dual BEF’ (DBEF), e.g., to polarise light for a liquid crystal light valve array and to reflect light not of the desired polarisation for the liquid crystal light valve array to the backlight for re-reflection towards the DBEF, a thin film encapsulation (TFE) layer, a prismatic layer, a reflector, a partial reflector, a polariser, a diffuser, a barrier layer, an anti-reflective layer, or a collimator.

The circuitry layers for the light source and light modulator are each connected to the display device control system and are configured for control of the light source and the light modulator by the display device control system to output a desired image. The circuitry layer of the light modulator is for example configured for so-called active-matrix control of the light-modulator regions, by using a switching element (e.g., a thin film transistor (TFT)) per picture element, and appropriate application of electrical signals to the source and gate terminals of each TFT, to set each light modulator region to transmit a desired amount of light. The circuitry layer of the light source is configured to control light output by the LEDs, e.g., to switch on a particular zone of LEDs whilst leaving switched off other zones of LEDs. Depending on the number of LEDs and their layout, the circuitry layer of the light source may even comprise switching elements (e.g., TFTs) for active matrix control of the LEDs.

The display device control system is connected to the circuitry layers and the common electrode by signal lines. The display device control system has for example a data input for receiving data representative of one or more images for the display device to display. As the skilled artisan will appreciate, the display device control system comprises circuitry for (and based on data representative of an image to be displayed) determining and applying appropriate electrical signals to the electrodes of the light modulator and the LEDs of the light source.

As the skilled artisan will appreciate, the magnitude of voltage applied between the common electrode and the electrode of a light modulator region of a given picture element, and therefore the size of the applied electric field, determines a rotational orientation of the LC molecules through the picture element relative to the alignment set by the alignment layer and also relative to the linear polarizer layers. Thus the extent of light modulation of each light modulator region can be controlled, and in turn the amount of light transmitted which is either aligned with the alignment layer or at least partly rotated in orientation relative to the alignment layer.

As the skilled artisan will appreciate, other types of examples are envisaged which have a light modulator in combination with a light source, but which use a technology (e.g., microelectromechanical (MEMs) or electrophoretic technology) distinct from LC technology for light modulation.

Examples are further envisaged where LEDs of the light source each correspond to a respective picture element, and are controllable to modulate light output by each picture element, rather than using a separate light modulator in combination with the illumination device. For example, each sub-pixel may comprise a blue LED, and a plurality of sub-pixels may be illuminated by one white LED, or instead a green and a red LED. By appropriate control of each blue LED and the green and red LEDs, a colour of an image output by the display device can be adjusted.

A display device as described herein may be, e.g., a display panel, display unit or display screen for an apparatus such as: a television, a computer monitor, a tablet computing device, a laptop computing device, a mobile telecommunications device such as a smart phone, a portable (e.g., mobile) device, an electronic reader device, a watch, a satellite navigation device, a heads-up display device, a game console, a flexible display, an extended reality (XR) device, a virtual reality (VR) device, and/or an augmented reality (AR) device.

The display device, for example, may be incorporated into apparatus comprising: the display device, at least one processor; and at least one memory comprising computer program instructions, the at least one memory and the computer program including instructions operable to, with the at least one processor, control the display device control system for controlling the display device to output an image.

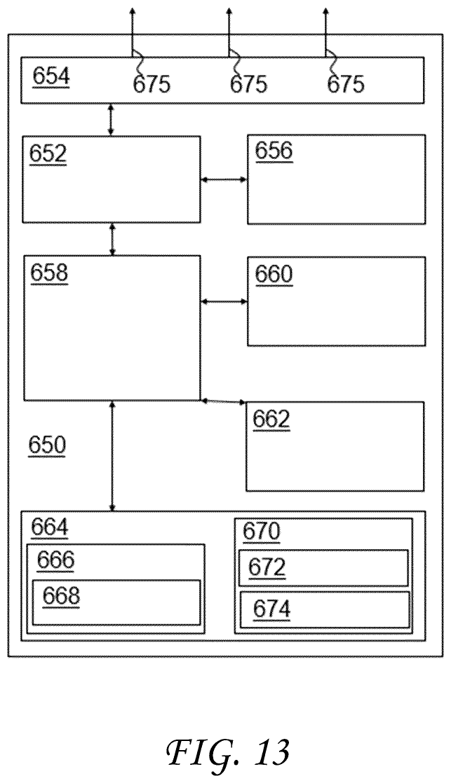

A system diagram illustrating an example of a basic hardware architecture of the system 650 is shown in FIG. 13, an electronic device such as a laptop computing device. Note that in other implementations some of the components shown in FIG. 13 are not present; for example for a computer monitor implementation, the system storage and/or battery may not be present. The system 650 comprises: the display device 654; at least one processor 658 connected to and therefore in data communication with, for example, a display device control system 652 (e.g., according to examples described earlier), a communications system 656, a user input system 660, a power system 662 and system storage 664. The display device control system is connected to and is therefore in data communication with the display device 654.

The display device control system 652 for example includes driver components for use in applying a voltage to any of the picture elements, to address different such picture elements. In examples the light modulator regions of the picture elements are driven using an active-matrix control scheme and the display device control system is configured to control switching elements such as thin film transistors (TFTs) of the display device 654 via circuitry to control the picture elements. The circuitry may include signal and control lines. For example, the display device control system 652 may include display drivers such as display column drivers and display row drivers.

The at least one processor 658 herein is, for example: a general-purpose processor; a microprocessor; a digital signal processor (DSP); an application specific integrated circuit (ASIC); a field programmable gate array (FPGA); a programmable logic device; a discrete gate or transistor logic; discrete hardware components; or any suitable combination thereof configurable for the functions described herein. A processor may be a combination of computing devices such as: a DSP and a microprocessor; a plurality of microprocessors; a microprocessor in conjunction with a DSP core; or any other such configuration. The processor 658 may be coupled, via one or more buses, to read information from or write information to a memory of the storage. The processor 658 may additionally, or in the alternative, contain a memory, such as a processor register.

The communications system 656 is for example configured for the system 650 to communicate with, for example, a computing device via a data network; a computer network such as the Internet; a local area network (LAN); a wide area network (WAN); a telecommunications network, a wired network, a wireless network, or an other network. The communications system may comprise: an input/output (I/O) interface such as a universal serial bus (USB) connection, a Bluetooth connection, or infrared connection; or a data network interface for connecting the apparatus to a data network such as any of those described above. Content data as described later may be transferred to the system via the communications system.

The user input system 660 may comprise an input device for receiving input from a user of the system. Example input devices include, but are not limited to, a keyboard, a rollerball, buttons, keys, switches, a pointing device, a mouse, a joystick, a remote control, an infrared detector, a voice recognition system, a bar code reader, a scanner, a video camera (possibly coupled with video processing software to, e.g., detect hand gestures or facial gestures), a motion detector, a microphone (possibly coupled to audio processing software to, e.g., detect voice commands), a VR glove, AR glove, a haptic input device, a computer vision device, a simultaneous localization and mapping (SLAM) device, an eye-tracking device, a hand-tracking device, or other device capable of transmitting information from a user to the device. The input device may also take the form of a touch-screen associated with the display device 654, in which case a user responds to prompts on the display device 654 by touch. The user may enter textual information through the input device such as the keyboard or the touch-screen.

The system may also include a user output system (not illustrated), including for example an output device for providing output to a user of the system. Examples include, but are not limited to, a printing device, an audio output device including for example one or more speakers, headphones, earphones, alarms, or haptic output devices. The output device may be a connector port for connecting to one of the other output devices described, such as earphones.

The power system 662 for example includes power circuitry for use in transferring and controlling power consumed by the system. The power may be provided by a mains electricity supply or from a battery (not shown), via the power circuitry. The power circuitry may further be used for charging the battery from a mains electricity supply.

The storage 664 includes a memory, for example at least one volatile memory 666 and non-volatile memory 670 and may comprise a non-transitory computer readable storage medium. The volatile memory may for example be a Random Access Memory (RAM). The non-volatile (NV) memory may for example be a solid-state drive (SSD) such as Flash memory or Read Only Memory (ROM). Further storage technologies may be used, for example, magnetic, optical or tape media, compact disc (CD), digital versatile disc (DVD), Blu-ray or other data storage media. The volatile and/or non-volatile memory may be removable or non-removable.

Any of the memories may store data for controlling the system. Such data may for example be in the form of computer readable and/or executable instructions, for example computer program instructions. Therefore, the at least one memory and the computer program instructions may be operable to, with the at least one processor, control the display device control system for controlling the display device 654 to output an image.

In the example of FIG. 13, the volatile memory 666 stores for example display device data 668 which is indicative of an image to be provided by the system. The processor 658 may transmit data, based on the display device data 668, to the control system 652 which in turn outputs signals to the display device for applying voltages to the picture elements, for displaying an image 675. The non-volatile memory 670 stores for example program data 672 and/or content data 674. The program data is for example data representing computer executable instructions, for example in the form of computer software, for the system to run applications or program modules for the system or components or systems of the system to perform certain functions or tasks, and/or for controlling components or systems of the system. For example, application or program module data includes any of routines, programs, objects, components, data structures or similar. The content data is for example data representing content for example for a user; such content may represent any form of media, for example text, at least one image or a part thereof, at least one video or a part thereof, at least one sound or music or a part thereof. Data representing an image, or a part thereof is for example representative of an image to be provided by at least one picture element of the display device. Such data may include content data of one type but may instead include a mixture of content data of different types, for example a movie may be represented by data including at least image data and sound data.

The term ‘about’ indicates that a numerical value may be approximate. This may be due to acceptable functional and/or measurement tolerances. For example, an approximation allows for ±5% of the quoted numerical value.

The term nanostructure as used herein refers for example to a structure having at least one region or characteristic dimension with a dimension of less than about 500 nm. In some examples the nanostructure has a dimension of less than about 200 nm, less than about 100 nm, less than about 50 nm, less than about 20 nm. or less than about 10 nm. Typically, the region or characteristic dimension will be along the smallest axis of the structure. Examples of such nanostructures include nanowires, nanorods, nanotubes, branched nanostructures, nanodots, quantum dots (QDs), nanoparticles, and the like. In some examples each of the three orthogonal dimensions of the nanostructure has a dimension of less than about 500 nm, less than about 200 nm, less than about 100 nm, less than about 50 nm, less than about 20 nm, or less than about 10 nm.

The term ‘quantum dot’ or ‘QD’ as used herein refers for example to nanostructures that are substantially monocrystalline (e.g., comprising a single crystal). E.g., a QD may have a core-shell structure; the core is substantially monocrystalline and may have one or more shells thereon. A QD, e.g., has at least one region or characteristic dimension with a dimension of less than about 500 nm, and down to the order of less than about 1 nm. In some examples the QDs have a maximum dimension of between about 2 nm and about 30 nm. Quantum dots described herein can be considered fluorescent semiconductor structures each with a semiconductor crystallite with a diameter less than or equal to twice the Bohr radius of an exciton inducible in the semiconductor crystallite. Such a radius results in quantum confinement of the exciton when induced in the semiconductor crystallite. The Bohr radius depends on the elemental composition of the semiconductor crystallite. For example, the Bohr radius of cadmium selenide (CdSe) is 5.4 nanometres, so a quasi-spherical CdSe semiconductor crystallite is a quantum dot if its radius is less than 5.4 nanometres. Further examples include: zinc selenide telluride (ZnSeTe) crystallites with a diameter between 4 and 5 nanometres, which are blue-light emitting quantum dots; indium phosphide (InP) crystallites with a diameter between 2 and 2.5 nanometres, which are green-light emitting quantum dots; and InP crystallites with a diameter between 2.8 and 3.5 nanometres, which are red-light emitting quantum dots. The quantum confinement of excitons results in fluorescence. Quantum confinement may be inducible in three dimensions, two dimensions (a quantum wire), or one dimension (a quantum well). Other morphologies of the semiconductor crystallite are envisaged such as cuboids or tetrahedrons. The quantum dots may comprise at least one of the following alloys: a III-V semiconductor, a II-VI semiconductor, zinc telluride selenide (ZnTeSe), zinc telluride (ZnTe), zinc selenide (ZnSe), zinc sulfide (ZnS), indium phosphide (InP), indium gallium phosphide (InGaP), indium arsenide (InAs), indium zinc phosphide (InZnP), indium arsenide (InAs), indium arsenide phosphide (InAsP), indium gallium arsenide phosphide (InGaAsP), silver indium gallium sulfide (AgInGaS or AIGS), copper indium sulfide (CuInS or CIS), copper indium gallium selenide (CuInGaSe or CIGS), cadmium selenide (CdSe), cadmium sulfide (CdS), cadmium telluride (CdTe), cadmium selenide telluride (CdSeTe), cadmium zinc selenide (CdZnSe), molybdenum sulphide (MoS), or an alloy thereof. The ratio(s) between the elements of alloys is not indicated, and various ratios are envisaged within as the skilled person will appreciate. The quantum dots may each comprise a core-shell structure with at least one shell on a core, the diameter of the core corresponding with, or less than, 2× the Bohr radius. The shell, for example, is a metal sulfide and/or a metal oxide. Example core-shell structures may be formed from CdSe (core)/CdS/ZnS, or InP (core)/ZnSe/ZnS. The quantum dots may be functionalised with at least one ligand, for example, a poly-ethylene-glycol, a poly-thiol, and/or a carboxylate. A shell and/or ligand functionalisation may enhance the properties of the quantum dots such as the quantum yield, thermal stability and/or photo-stability. The quantum dots may be encapsulated to, for example, reduce the toxicity of the quantum dots. Many encapsulants are envisaged, such as a silane or a metal oxide, as the skilled person will appreciate.

The term ‘maximum dimension’ in relation to a structure refers, e.g., to the largest straight-line measurable distance of that structure in any direction. For example, in the context of a spherical structure, the maximum dimension is a diameter.

The term ‘thickness’ in relation to a film, coating, layer or the like refers, e.g., to the depth of that film, coating or layer. E.g., if the film or layer is planar, the thickness relates to the distance measured orthogonally to that plane.

The above examples are to be understood as illustrative examples. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A composition comprising:
a carrier matrix;
a plurality of photoluminescent nanostructures distributed within the carrier matrix;
a hindered amine stabilizer; and
at least one of (i) an alkylalkoxysilane and a coordination polymer, or (ii) a silanized coordination polymer.

2. The composition of claim 1 wherein the plurality of photoluminescent nanostructures comprise one or more of indium phosphide (InP)-based quantum dots, silver indium gallium sulfide (AIGS)-based quantum dots, or cadmium selenide (CdSe)-based quantum dots.

3. The composition of claim 1, wherein the at least one of (i) the alkylalkoxysilane and the coordination polymer or (ii) a silanized coordination polymer and the hindered amine stabilizer are stabilizing additives, and wherein the stabilizing additives and the plurality of photoluminescent nanostructures are distributed together as heterogeneous domains within the carrier matrix, such that the photoluminescent nanostructures are in direct contact with the stabilizing additives.

4.-17. (canceled)

18. The composition of claim 1 further comprising a support particle.

19. The composition of claim 18 wherein the support particle comprises a material for scattering light of at least one of: a wavelength absorbed by the luminescent nanostructures or a wavelength emitted by the luminescent nanostructures.

20. The composition of claim 18 wherein the support particle has a band gap of greater than 3 eV.

21. The composition of claim 18 wherein the support particle comprises at least one of:
an inorganic material, a metal oxide, a metal sulfide, or one or more of SiO₂, TiO₂, ZnO or ZnS.

22. The composition of claim 18 further comprising a coating at least partially surrounding the support particle.

23. The composition of claim 22 wherein the coating is formed from at least one of:
a) at least one material selected from the group consisting of: an alkoxy silane with a linear or branched alkyl substituent; an alkoxy silane with at least one phenyl, mercapto, or amino substituent; an alkoxy silane with at least one cross-linkable reactive functional group; an alkoxy silane with at least one halide functional group; a tetra-alkoxy silane; an alkali, alkaline earth or transition metal silicate; or a group (IV) or transition metal alkoxide; and/or
b) at least one material selected from the group consisting of: a metal thiolate; a metal carboxylate; a fluoropolymer; a butylene/isoprene copolymer; a styrene-ethylene/butylene-styrene copolymer; a styrene-ethylene/propylene-styrene copolymer; polyvinylidene dichloride or a high boiling point wax.

24. The composition of claim 22 wherein the coating comprises a silanized coordination polymer.

25. The composition of claim 22 wherein the coating comprises a silanized coordination polymer which is the reaction product of an alkyl alkoxy silane and a metal thiolate.

26. The composition of claim 1 wherein the coordination polymer comprises a metal thiolate.

27.-31. (canceled)

32. The composition of claim 4 wherein the support particle has a maximum dimension between 100 nm and 10 μm.

33. The composition of claim 9 wherein the thickness of the coating is between about 10 nm and 500 nm.

34. A method of forming a structure containing support particles, the method comprising:
a) mixing luminescent nanostructures with at least one of: a coating material or one or more pre-cursor for the coating material, to form a first mixture;
b) contacting the first mixture with a support particle; and
c) forming a coating from the first mixture, the coating at least partially surrounding the support particle, the luminescent nanostructures within the coating. PRELIMINARY AMENDMENT
